(19) United States
(12) Patent Application Publication
(10) Pub. No.: US 2020/0213081 A1
(43) Pub. Date: Jul. 2, 2020

(54) METHOD FOR CRYPTOLOGICALLY SECURING AN ADDITIVE PRODUCTION PROCESS

(71) Applicant: Covestro Deutschland AG, Leverkusen (DE)

(72) Inventor: Hans KESPOHL, Frechen-Königsdorf (DE)

(21) Appl. No.: 16/631,287

(22) PCT Filed: Jul. 13, 2018
(86) PCT No.: PCT/EP2018/069070

§ 371 Date: Jan. 15, 2020

(30) Foreign Application Priority Data
Jul. 17, 2017 (EP) 17181618.4

(51) Int. Cl. H04L 9/06; H04L 9/32; B33Y 50/02; B29C 64/393

(52) U.S. Cl. CPC H04L 9/065; H04L 9/3247; H04L 2209/38; B33Y 50/02; B29C 64/393; H04L 9/0637

(57) ABSTRACT

The invention relates to a method for cryptologically securing an additive production process, wherein a data stream (1) has cryptologically linked elements (2) for describing the production process, wherein the elements (2) have at least one definition data set (3a-c) for defining an object (4a, b) for an additive production, wherein the at least one definition data set (3a-c) defines the object (4a, b) spatially for the additive production, at least in part, and defines a starting material (17) of the object (4a, b) for the additive production and wherein the at least one definition data set (3a-c) is inserted into the data stream (1) by a respective originator (6a-c) and the cryptological linking is extended to the at least one definition data set (3a-c), wherein the data stream (1) is transferred via a system of computer networks (12) to a device for additive production (13a, b) for producing the object (4a, b) by means of additive production, wherein the integrity of the cryptological linking is examined and wherein the device for additive production (13a, b) produces the object (4a, b) by means of additive production based on the at least one definition data set (3a-c). The invention further relates to a corresponding data stream (1) for cryptologically securing an additive production process and to a corresponding system for cryptologically securing an additive production process.

The invention relates to a method for cryptologically securing an additive production process, to a data stream for cryptologically securing an additive production process, and to a system for cryptologically securing an additive production process.

Among the known production methods, which include both molding methods, for example injection molding, and also forming or severing methods, the additive production methods, in which objects are built up layer-by-layer, are gaining more and more significance. This applies in particular to computer-controlled 3D printing, which practically opens up the possibility of defining an object completely in electronic form and then, based on this definition, having it be produced by one or more 3D printers, which can in principle be arranged distributed and at arbitrary locations. Since the electronic data may also be exchanged as desired between different users, who are potentially distributed worldwide, not only can a physical supplier chain for the production of the object between individual locations be substantially dispensed with—except for the possibly required transportation of the starting materials—but rather there are also many possibilities for the cooperation from distributed locations during the creation of the definition of the object in electronic form. Furthermore, in modern economic processes, a documentation over the entire production or usage cycle of specific objects can regularly also additionally be advantageous or even prescribed. This can also relate in particular to the disposal or recycling of the object after the end of the regular use. As a result, there is an entire array of electronic data from potentially entirely different sources in the case of an object produced according to an additive production method, which are to be retained over a long time, linked in the entirety thereof to the object, and potentially supplemented over the entire usage time of the object.

It is known per se that the producer of a complex product in particular assigns a serial number to every exemplar of this product and retains the production data and possibly additional data occurring in the course of use in an internal database. This is acceptable in the case of conventionally produced products for example, passenger automobiles—because a single company is uniquely identifiable as the producer of the product and thus as responsible and because the supply of subcomponents—i.e., of individual parts of the passenger automobile—to this company also essentially takes place in the form of physical components. In the case of an above-described distributed process in additive production, however, it is unequally more difficult to identify a producer primarily responsible in this meaning, since the actual production process in a 3D printer is frequently assigned less importance overall than the design, the definition of the starting materials, and the provision of the starting materials. In contrast, if each of the parties directly or indirectly participating in the production of the object and the customer and future user each manage the data respectively associated with them separately and more or less as a plurality of “island solutions” per se, a reliable compilation of these data corresponding to documentation standards is difficult both from a technical and also an organizational aspect.

Against this background, the object of the invention is therefore to provide a technical teaching which, even in the case of a strongly distributed process in the additive production of an object, enables the design, production, and use of this object to be tracked and retained as extensively as desired in principle in a transparent and manipulation-secure manner.

This object is respectively achieved by a method for cryptologically securing an additive production process having the features of claim 1, by a data stream for cryptologically securing an additive production process having the features of claim 14, and by a system for cryptologically securing an additive production process having the features of claim 15.

The finding that all essential items of information on an object which is to be additively produced or is additively produced can be bundled in a data stream, the elements of which are cryptologically linked, is essential to the invention. On the one hand, this prevents elements inserted once into the data stream from being modified later unnoticed and, on the other hand, enables the data stream to be distributed among a plurality of users, so that no single party primarily or exclusively responsible for the maintenance of the data stream—whether among the users or externally—has to be defined. It is then also readily possible that individual users leave and new users are added, without this placing the integrity of the data stream into question.

The proposed method is used for cryptologically securing an additive production process. An additive production process is to be understood in this case as the entire complex of processes which are part of additive production in the above-described meaning. In other words, the additive production process comprises not only the additive production per se—i.e., the physical act of producing or manufacturing an object—but rather also the definition of the object and/or of the production preceding the production, measurements on the produced object following the production, and all further processes which relate to the further use of the object up to the disposal, recycling, or other utilization of the object.

According to the proposed method, a data stream comprises cryptologically linked elements for describing the production process. The concept of a data stream is to be understood as a fundamentally arbitrary sequence of the elements. These elements are data for describing the production process according to the above-described, broad meaning. The cryptological linking of the elements means that the integrity of the data stream is cryptologically secured. In other words, any subsequent modification or erasure of one of the already existing elements of the data stream or another modification in the constellation thereof is recognizable. This cryptological linking can be carried out in a manner known from the prior art which is arbitrary per se, wherein special examples of such a cryptological linking are described hereafter.

According to the proposal, the elements comprise at least one definition dataset for the definition of an object for additive production. In other words, every element which defines the additive production in the narrower meaning in a fundamentally arbitrary manner is a definition dataset. Elements which relate to substantive matter after completion of the additive production in the narrower meaning, for example to a quality check, are accordingly not definition datasets.

According to the proposal, the at least one definition dataset at least partially spatially defines the object for the additive production and the at least one definition dataset defines a starting material of the object for the additive production.

Furthermore, according to the proposal, the at least one definition dataset is inserted into the data stream by a respective author and the cryptological linking is expanded to the at least one definition dataset. In this case, the above at least partial spatial definition of the object for the additive production and the definition of the starting material of the object for the additive production can be distributed arbitrarily in principle onto the at least one definition dataset. It can thus be that there is only one single definition dataset, which comprises both the at least partial spatial definition of the object for the additive production and also the definition of the starting material of the object for the additive production.

However, it can also be that two definition datasets are provided, of which one geometry dataset defines the object at least partially spatially for the additive production and a separate material dataset defines a starting material of the object for the additive production. With a plurality of definition datasets, these definitions can be distributed arbitrarily onto these definition datasets. The author of the respective definition dataset can also be the same author in the case of various definition datasets. Different authors can also exist for geometry dataset and definition dataset.

The expansion of the cryptological linking to the at least one definition dataset means that the elements of the data stream and in particular the inserted definition datasets are also cryptologically linked in particular after this insertion.

The at least partial spatial definition of the object for the additive production can comprise both items of information on an extension of the object in various dimensions and also on a location or alignment of the object. It can be performed in particular by an STL file (STereoLithography, Standard Triangle Language, or Standard Tessellation Language) comprised by the at least one definition dataset. The at least partial spatial definition of the object for the additive production can also comprise a position specification about where spatially on an already existing semifinished product additive production is to be performed to produce the finished object.

The definition of the starting material of the object relates in particular to the components and the composition of the object during the additive production, i.e., in particular the material additively added during the production, wherein those components are also comprised thereby which are only used temporarily during the additive production and which are therefore no longer a component of the produced object after completion of the additive production. The respective author involves persons or devices who or which are each arbitrary in principle, for example a corresponding computer.

According to the proposed method, the data stream is transferred via a system of computer networks to a device for additive production to produce the object by means of additive production and the integrity of the cryptological linking is checked. This check can be performed in particular by the device for additive production. The system of computer networks, which can thus be arbitrarily extensive in principle and in particular can be global, can be the Internet in particular. According to the proposed method, the device for additive production based on the definition datasets produces the object by means of additive production. In other words, the production of the object by the device for additive production is based in any case on the at least one definition dataset.

The concept of additive production is to be understood broadly in the present case, so that any production steps are comprised by the term in which material is added to produce the object. On the one hand, this comprises 3D printing in the narrower meaning. On the other hand, however, this also includes processes in which the respective material is also added to an already existing blank, a semifinished product, or another precursor component. The application of a coating such as a paint or a wear layer is thus also included in additive production. It can also be that only a part of an object and in particular only a surface structure is additively applied to a semifinished product by 3D printing. Accordingly, in the case of this additive production by the device for additive production it can be that the additive production builds on components which have already been previously produced, and possibly also by a different and potentially non-additive manner of production. For example, the additive production can be performed around a conventionally produced electronic component, which is then enclosed, for example, by the additively produced part of the produced object.

In principle, it can be that the above starting material of the object for the additive production and also other features of the object are distributed spatially homogeneously in the object. Spatial definition and starting material then do not have a special relationship. In contrast, one preferred embodiment of the proposed method is characterized in that the at least one definition dataset for a spatial region of the object defines a property of the object varying in dependence on a spatial position in the region. In other words, the property is a function of the spatial position in the region, which is not constant in the entire region. This spatial region of the object can be both a partial region of the object and also the object as a whole. In this manner, desired spatial inhomogeneities of the object can be taken into consideration during the additive production. The property of the object is preferably a functional property. These can include a modulus of elasticity, a temperature coefficient, a density, a resistance, or another physical property. It can also be that the property of the object is a material composition. Such a property can also be the presence or absence of a specific feature. Alternatively or additionally, it can be that the property of the object is defined per voxel of the region. Such a voxel is a spatial grid point in three-dimensional analogy to a pixel. An in particular cube-shaped standard volume element can also be associated with each voxel, so that the set of all voxels fills up the region essentially completely.

In principle, the at least one definition dataset can define arbitrary types of materials which are suitable for 3D printing, thus, for example, also artificial resins, ceramics, or metals. One preferred embodiment of the proposed method is characterized in that the at least one definition dataset for the definition of the starting material defines one or more thermoplastic materials. The at least one definition dataset preferably also defines a particle size and/or a melting property, comprising melting point and/or melting range and also melting viscosity, for these materials. The at least one definition dataset can also define at least one plasticizer of the starting material. Furthermore, it can be that the thermoplastic materials, the particle size, the melting property, and/or the plasticizer is defined in a varying manner for the spatial region of the object in dependence on a spatial position in the region.

A further preferred embodiment of the proposed method is characterized in that the at least one definition dataset defines a production process of the object. The definition of the production process can relate in particular to the type of the layer buildup. It can thus be specified how finely or coarsely the layers are to be applied. It is preferable here for the at least one definition dataset to define a method for melt layering (fused filament fabrication, FFF or fused deposition modeling, FDM), selective laser sintering, selective laser melting, or high-speed sintering (HSS), possibly with the respective linked process parameters, as the production process of the object.

The term “melt layering method” denotes a production method from the field of additive production, using which a workpiece is built up layer-by-layer, for example, from a meltable plastic. The plastic can be used with or without further additives such as fibers. Machines for FDM/FFF belong to the machine class of 3D printers. This method is based on the liquefying of a wire-shaped plastic or wax material by heating. The material solidifies during the subsequent cooling. The material application takes place by extrusion using a heating nozzle freely movable in relation to a production plane. In this case, either the production plane can be fixed and the nozzle is freely movable or a nozzle is fixed and a substrate table (having a production plane) can be moved or both elements, nozzle and production plane, are movable. The speed at which the underlying surface and the nozzle are movable in relation to one another is preferably in a range of 1 to 200 mm/s. Depending on the application, the layer thickness is in a range of 0.025 and 1.25 mm, the exit diameter of the material jet (nozzle outlet diameter) of the nozzle is typically at least 0.05 mm.

During the layer-by-layer model production, the individual layers thus bond together to form a complex part. The buildup of a body typically takes place repeatedly, in each case one work level is moved down line-by-line (formation of a layer) and then the work level is displaced upward in a “stacking” manner (forming at least one further layer on the first layer), so that a shape results layer-by-layer. The exit temperature of the material mixtures from the nozzle can be, for example, 80° C. to 420° C. It is moreover possible to heat the substrate table and/or a possibly provided installation space, for example, to 20° C. to 250° C. In this way, excessively rapid cooling of the applied layer can be prevented, so that a further layer applied thereon bonds sufficiently to the first layer.

Sintering methods in the context of the present invention are methods which use thermoplastic powder in particular to build up objects layer-by-layer. In this case, thin powder layers are applied via a so-called coater and subsequently selectively fused by means of an energy source. The surrounding powder supports the component geometry in this case. Complex geometries are thus to be manufactured more cost-effectively than with the FDM method. Moreover, various objects can be arranged and/or produced closely packed in the so-called powder bed. Because of these advantages, powder-based additive production methods are among the most cost-effective additive production methods on the market. They are therefore predominantly used by industrial users. Examples of powder-based additive production methods are so-called laser sintering (SLS, selective laser sintering) or high-speed sintering (HSS). They differ from one another in the method for introducing energy for the selective fusion into the plastic. In the laser sintering method, the energy introduction takes place via a deflected laser beam. In the so-called high-speed sintering (HSS) method, the energy introduction takes place via infrared (IR) radiators in combination with an IR absorber selectively printed in the powder bed. The so-called selective heat sintering (SHS) uses the printing unit of a conventional thermal printer to selectively fuse thermoplastic powder. Selective laser sintering methods (SLS) are preferred.

One preferred embodiment of the proposed method is characterized in that the elements are each digitally signed. Digital signatures are also known from the prior art and represent an asymmetrical cryptography system, by which the indisputable authorship and the integrity of the digitally signed data, i.e., each individual element here, can be checked. In the present case, each element is digitally signed by the respective author of the element. It is preferable for the respective author to digitally sign the at least one definition dataset during the insertion. Furthermore, it can be that, during the checking of the integrity of the cryptological linking, the digital signatures are checked, in particular by the device for additive production.

In principle, sorting of the elements is not required in the data stream. However, a preferred embodiment of the proposed method is characterized in that the elements of the data stream are sorted according to a sequence. In principle, the foundation for the sorting can initially be arbitrary in this case. However, it is preferable in this case for the elements of the data stream to comprise a respective timestamp at the point in time of the preparation of the respective element, and for the sequence according to which the elements of the data stream are sorted to correspond to the chronological sequence according to the respective timestamp. Such timestamps can each comprise the specification of an absolute time, wherein it can be in particular the specification of a global time, for example the coordinated universal time UTC typical in air travel in particular. However, it can also be that the timestamps are merely used for the relative chronological ordering of the preparation of the elements. It is therefore sufficient, for example, for the timestamps to only provide information about which timestamp is earlier or later than another timestamp and thus not to make any specification about the length of the respective time interval between the timestamps.

According to one preferred embodiment of the proposed method, it is provided that the elements of the data stream are cryptologically linked in that the data stream comprises a cryptological element hash value of the respective element for at least some, preferably all, elements, and the data stream comprises a series of cryptological meta-hash values, which are each based on an element hash value. This means that the element hash value forms at least part of the starting data in the computation of the respective meta-hash value. In addition, there can also be further cryptological meta-hash values which are based on meta-hash values. Such further meta-hash values can be formed by applying a hash function to two or more meta-hash values, so that the resulting structure of the meta-hash values corresponds to a hash tree known per se from the prior art, which is also referred to as a “Merkle tree”.

Furthermore, it is preferable for the meta-hash values to form a linked list, wherein the meta-hash values are based on a respective element hash value and a preceding meta-hash value in the list. In this case, each meta-hash value can be assigned to one element and another meta-hash value can be assigned to each meta-hash value as a preceding meta-hash value. Especially for a specific meta-hash value, this preceding meta-hash value can be the meta-hash value which is assigned to the element which, according to the above sorting of the elements, precedes the element to which is assigned the specific meta-hash value. In other words, the sequence of the linked list of the meta-hash values according to the assignment of the preceding meta-hash values corresponds to the sequence in which the elements are sorted. In this case, an initial value, which is not assigned to any element, can be assigned to a first meta-hash value of the list as the preceding meta-hash value. The circumstance is therefore taken into consideration that the sequence of the elements according to sorting also recognizes a first element which no other element precedes. By forming such a linked list, the data stream can be checked as to whether a later manipulation of the elements of the data stream took place, including a modification within an element and also a removal or insertion of an entire element or another modification of the sequence of the elements.

Furthermore, it can be that the element hash values and/or the at least one meta-hash value are based on a key-dependent hash function. In a data stream having a large number of elements, the processing effort for checking the integrity can thus be reduced.

A further preferred embodiment of the proposed method is characterized in that a plurality of processors, comprising the respective authors of the at least one definition dataset (3a-c), inserts a new element into the data stream—wherein preferably the inserting processor digitally signs the new element upon inserting the new element—and the cryptological linking of the elements is expanded to the new element. In addition to the authors, further processors can also be present, which expand the data stream in this manner. The processors in this meaning are preferably computers or processing devices.

Such a processor could, for example, add a definition dataset for defining a tolerance of the additive production of the object. A processor which is a buyer could also insert an order for an exemplar of the object described by the data stream as an element into the data stream. In that every inserted element is preferably digitally signed and cryptologically linked, the corresponding procedure remains documented and secured and can be tracked. It is furthermore preferable here for the inserted new element to be inserted as the last element of the sequence. In other words, the sequence of the elements already present in the data stream in relation to one another is preserved.

According to one preferred embodiment of the proposed method, it is provided that, after inserting a new element, the data stream is transferred via the system of computer networks to a plurality of users, preferably comprising the processors, and stored in each case. In this manner, every current data stream can be compared to its history. The greatest possible number of users enables comprehensive documentation and monitoring. In this case, it is not necessary for the receiving users to also be authorized themselves to insert new elements. The above transmission preferably even takes place after every insertion of a new element. Furthermore, it is preferable for the integrity of the cryptological linking and preferably also of the digital signatures to be checked by the plurality of users. Furthermore, it can be that, if a lack of integrity is established, the establishing user transmits a warning message to the plurality of users. As a particularly secure design of such a distributed monitoring, one preferred variant provides that the plurality of users forms a distributed database which manages the data stream as a block chain. Such a block chain is known per se from the prior art and is used, for example, in the cryptocurrency bitcoin.

One preferred embodiment of the proposed method is characterized in that the plurality of processors comprises the device for additive production, and the device for additive production, after production of the object, inserts a production dataset having items of information on the process of the production of the object as a new element into the data stream. Since this is an insertion by a processor, an expansion of the cryptological linking to the new element also takes place here. Such items of information on the process of the production of the object can comprise, for example, the time required for the production, the location of the production, sensor data measured during the production, error messages possibly occurring during the production, and settings of the device for additive production during the production. It is preferable for the production dataset to also comprise a unique identifier of the produced object. This identifier can be, for example, a serial number. The concept of the produced object means the special exemplar of the object. If a further, identical object is produced, it is actually the identical object, but a different or further exemplar of the object and thus not the same produced object.

A further preferred embodiment of the proposed method is characterized in that the plurality of processors comprises a plurality of devices for additive production, which are each arranged remotely from one another and connected to one another by the system of computer networks and which each produce a respective object by means of the additive production based on the definition datasets. In this manner, the identical object can thus be produced in multiple exemplars at different locations and thus in a decentralized manner, whereby, in contrast to centralized production, the requirement of corresponding transportation of the produced products is dispensed with or at least ameliorated. Furthermore, it is preferable for the plurality of devices for additive production, after production of the respective object, to insert a respective production dataset having items of information on the process of the production of the respective object, preferably having a unique identifier of the respective produced object, as a respective new element into the data stream. The production occurring in each case at distributed locations is thus nonetheless documented in the same common data stream. In this manner, the production of all exemplars of the defined object can be traced.

According to one preferred embodiment of the method, it is provided that, during the production of the object by the device for additive production, the unique identifier of the produced object is introduced into the object, so that the identifier can be read out from the produced object. In other words, the identifier assigned to the produced object is also physically introduced into the produced object, so that the assignment of the produced object to the production dataset can be performed by examining the produced object. In principle, there are various options for such an introduction. The introduction of the identifier itself in the stricter sense can also be performed in a manner other than by an additive production method. Thus, for example, the additive production of the object could be performed around an existing RFID chip or comparable device having the identifier. In this manner, for example, the RFID chip would be arranged in the interior of the otherwise additively produced object. However, it would also be conceivable that the identifier itself is introduced by means of the additive production. This could be performed, for example, by inscribing a serial number during the 3D printing. Furthermore, it can be that the items of information on the process of the production of the object comprise items of process measurement information measured during the production of the object and/or items of object measurement information measured after the production of the object on the produced object. Such measurements can comprise, for example, the final dimensions of the produced object or temperatures or waiting times measured during the production. An intersection or overlap with the above items of information on the process of the production of the object can thus result.

One preferred embodiment of the proposed method is characterized in that the plurality of processors comprises a testing device for testing the produced object, the testing device carries out a test process on the produced object with measurement of test values, and the testing device, after carrying out the test process, inserts a test dataset having the measured test values as a new element into the data stream. Such a test of the produced object can be understood as any test having corresponding measurements downstream from the actual production, thus, for example, a conventional output or quality control, as has been known for some time from production. In principle, the testing device can also be identical to the device for additive production in this case. The testing device can also be separate from the device for additive production and can be arranged remotely therefrom. It is furthermore preferable for the test process to be carried out based on a test target, which test target is comprised as an element by the data stream. This test target was preferably inserted by a processor other than the testing device.

A further preferred embodiment of the proposed method is characterized in that the plurality of processors comprises a specification generator, which, chronologically before the insertion of the at least one definition dataset, inserts a specification profile having an application specification for the object as a new element into the data stream. This enables not only the design and production process to be executed in a distributed manner and simultaneously retained in a distributed but unified manner, but rather also this approach to be expanded to the precursor stage, namely the formulation of a specification. It is preferable here for the author to prepare the at least one definition dataset based on the specification profile. It is also preferable for the specification profile to comprise the above test target.

In principle, arbitrarily many exemplars of the object can be produced based on the at least one definition dataset. However, it can also be reasonable or desirable to limit the number of the produced objects. It is therefore provided according to one preferred embodiment of the proposed method that the data stream comprises an element having a batch dataset, which batch dataset defines a maximum number of objects to be produced based on the at least one definition dataset. Such a batch dataset can then be taken into consideration in different manners. One possibility provides in this case that the device for additive production and in particular the plurality of devices for additive production only produce the—in particular respective—object if the number of the produced objects according to the production datasets in the data stream is less than the defined maximum number. In particular the device for additive production can be configured to perform such a check and to produce the object only after the check. In this case, the number of the produced objects can correspond to the number of the production datasets. It can also be that one production dataset relates to multiple produced objects and therefore corresponds to equally many produced objects.

In addition to the above-described cryptological linking and the respective digital signature, still further cryptological measures can be provided in conjunction with the data stream. It can thus be, for example, that some or all elements of the data stream are each encrypted. It can also be that the data stream as a whole is encrypted.

The above-described various types of processors or users can partially also be implemented in a single device. In particular the respective authors of various elements or definition datasets can thus be a single and common device. Other combinations are also accordingly possible.

The proposed data stream is used for cryptologically securing an additive production process, wherein the data stream comprises cryptologically linked elements for describing the production process. According to the proposed data stream, elements comprise at least one definition dataset for defining an object for additive production, which at least one definition dataset defines the object at least partially spatially for the additive production and defines a starting material of the object for the additive production, and wherein the at least one definition dataset is configured for the purpose that a device for additive production produces the object by means of the additive production based on the at least one definition dataset.

The proposed system for cryptologically securing an additive production process comprises a respective author for inserting at least one definition dataset for defining an object for additive production into a data stream having cryptologically linked elements for describing the production process, wherein the at least one definition dataset defines the object at least partially spatially for the additive production and defines a starting material of the object for the additive production. Furthermore, the proposed system comprises a device for additive production for producing the object by means of the additive production based on the at least one definition dataset and a system of computer networks for transferring the data stream to the device for additive production, wherein the device for additive production is configured to check the integrity of the cryptological linking.

Preferred features, advantages, and designs of the data stream according to the proposal and the system according to the proposal result in each case from the features, advantages, and designs of preferred embodiments of the method according to the proposal and vice versa.

Further details, features, goals, and advantages of the present invention are explained hereafter on the basis of the drawing, which merely shows one exemplary embodiment. In the figures of the drawing

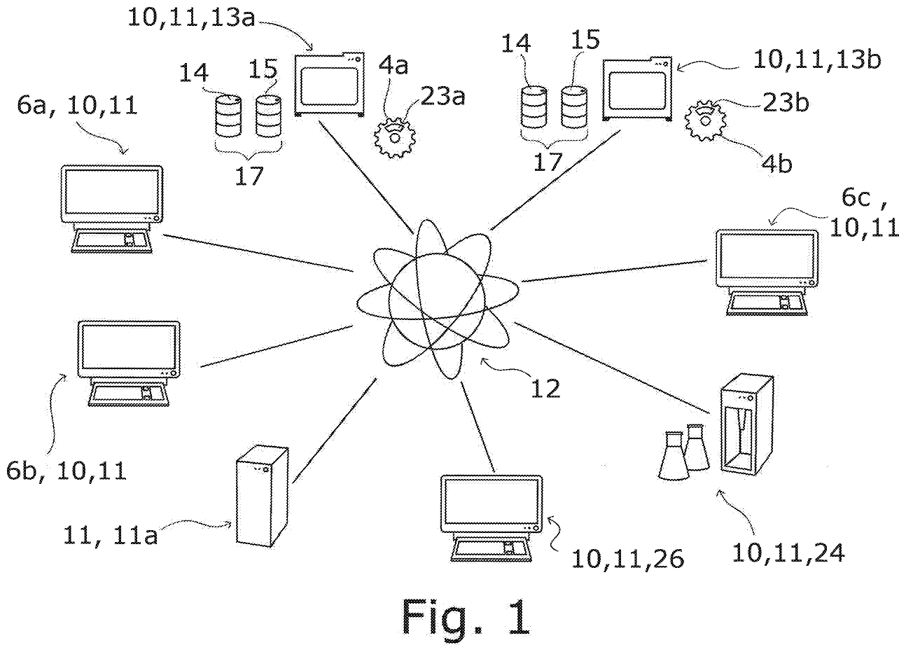

FIG. 1 schematically shows an exemplary embodiment of a proposed system, which is configured to execute the proposed method,

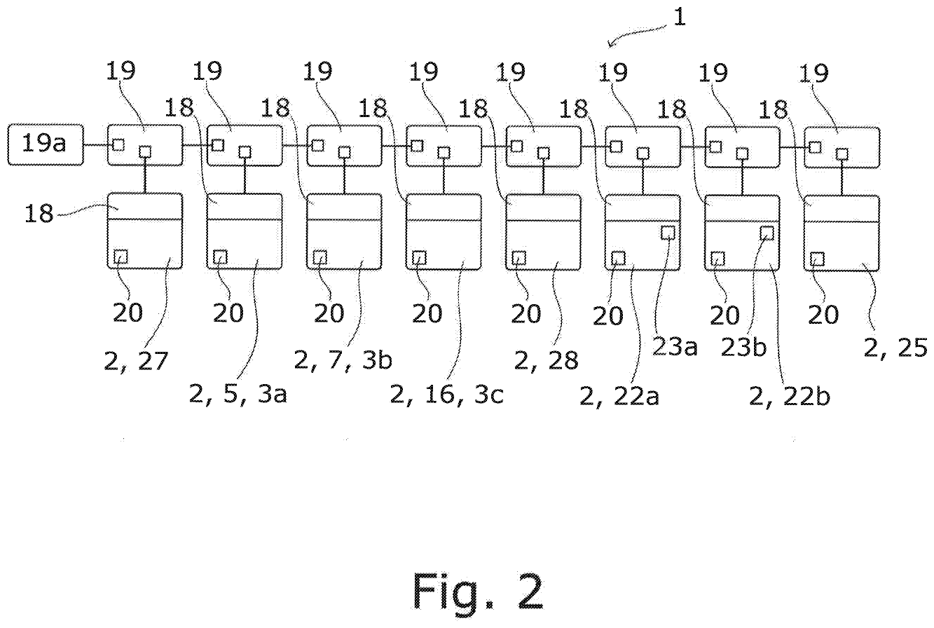

FIG. 2 schematically shows an exemplary embodiment of a proposed data stream for the system of FIG. 1, and

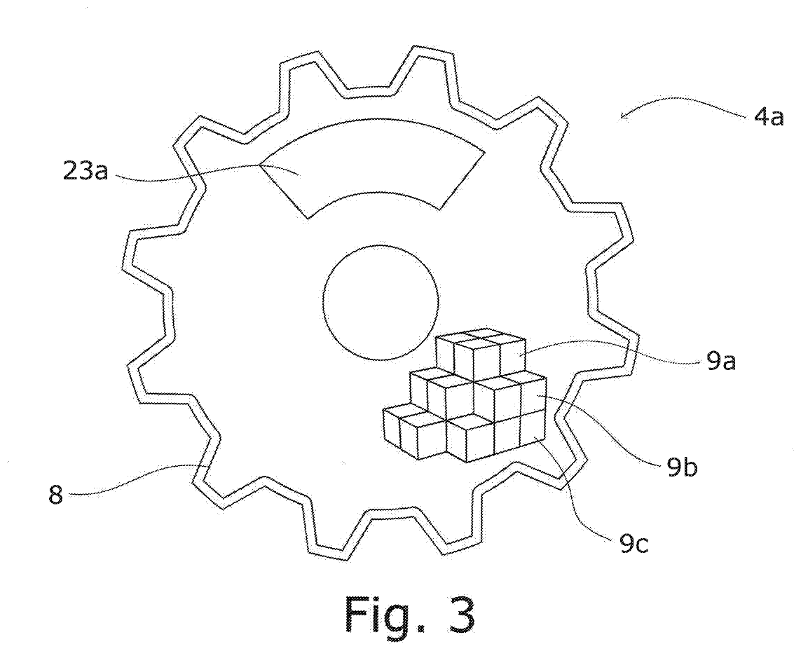

FIG. 3 schematically shows an object produced in the system of FIG. 1 having a property defined per voxel of the spatial region of the object.

The system illustrated in FIG. 1 is used for cryptologically securing an additive production process. It especially relates to the production of an object 4a, b, which is a gear wheel here by way of example and which is schematically shown in FIG. 3, by means of additive production. The system is essentially based in this case on the data stream 1 shown in FIG. 2. This data stream comprises a plurality of elements 2, which are cryptologically linked to one another. The elements 2 are also arranged in a sequence which corresponds to the sequence of the elements 2 from left to right in the illustration of FIG. 2.

The second element 2 according to this sequence is a geometry dataset 5, which spatially defines the object 4a, b. Since this geometry dataset 5 defines the object 4a, b for additive production, it is a definition dataset 3a. The third element 2 according to this sequence is also a definition dataset 3b, especially a material dataset 7, which defines the starting material 17 of the object 4a, b. The geometry dataset 5 and the material dataset 7 were each inserted by an author 6a, b, which is a computer in each case according to the illustration in FIG. 1, into the data stream 1 and cryptologically linked to the remaining data stream 1. The geometry dataset 5 was also digitally signed by its author 6a and the material dataset 7 was digitally signed by its author 6b, in the same manner as all elements 2 of the data stream 1 were digitally signed by the respective digital author thereof.

In this case, the material dataset 7 was prepared chronologically after the geometry dataset 5 and inserted into the data stream 1. The material dataset 7 does not define the starting material 17 homogeneously for the object 4a, b in this case, but rather provides here by way of example a different curing of the starting material 17 in a spatial region 8 of the object 4a, b, wherein this spatial region 8 encompasses the object 4a, b as a whole in the present case. The material dataset especially defines a stronger curing, a moderate curing, and a lesser curing as a respective property 9a-c of the object 4a, b, which is individually defined for each voxel in the spatial region 8 of the object 4a, b. FIG. 3 shows this by way of example for several voxels and the corresponding properties 9a-c of the object 4a.

The exchange of the data stream 1 between the processors 10—which are in particular the computers which are authorized to insert new elements 2 into the data stream 1—and with the users 11, which group, in addition to the processors 10, also comprises those which merely receive the data stream 1 and possibly also check it for cryptological integrity, takes place via a system of computer networks 12. The users 11—and thus also the processors 10—are all arranged at locations distributed worldwide. In the exemplary embodiment illustrated in the drawing, this system of computer networks 12 is the Internet; and specifically after each insertion of a new element 2 by an arbitrary processor 10, a transfer of the data stream 1 expanded in this manner takes place to all other users 11 and thus also to all other processors 10. The transferred data stream 1 is then stored by the respective receiving user 11. The process of insertion itself always includes a digital signature of the element 2 and an expansion of the cryptological linking to the new element 2, which is described in greater detail hereafter for the exemplary embodiment of FIG. 1. A database server 11a is shown as a user 11 by way of example in FIG. 1, which does in each case receive and store the data stream 1, but is not authorized or configured for inserting new elements 2 into the data stream 1.

The processors 10 also include, in addition to the above authors 6a, b of the geometry dataset 5 and the material dataset 7, the further author 6c, which, as the element 2 following the material dataset 7, has digitally signed a process technology dataset 16 having details on the layer buildup, which is also a definition dataset 3c, during the additive production and inserted it into the data stream 1.

The geometry dataset 5, the material dataset 7, and the process technology dataset 16 were prepared based on a specification profile 27, which was prepared chronologically before these definition datasets 3a-c by a processor 10 identified as a specification generator 26 and was inserted as the first element 2 of the data stream 1. This specification profile 27 specifies the requirements which the object 4a, b is to meet and therefore forms the foundation of both the geometry of the object 4a, b and also its material properties.

The processors 10 furthermore include two devices for additive production 13a, b, which are each a 3D printer in the present case and which produce a respective object 4a, b, defined by the entirety of the definition datasets 3a-c in the data stream 1, by means of additive production. The corresponding starting material 17 defined by the material dataset 7 comprising thermoplastic materials 14 and a plasticizer 15 is respectively also shown at a device for additive production 13a, b. Firstly, a first of the devices for additive production 13a has produced a first object 4a based on the definition datasets 3a-c and thereupon generated a first production dataset 22a, which is shown in FIG. 2 as part of the data stream 1, and inserted it into the data stream 1. This production dataset 22a comprises, in addition to items of information on the completed production process such as items of process measurement information, a unique identifier 23a of the object 4a, which identifier 23a is also a physical component of the object 4a, for example by providing a corresponding RFID chip. Subsequently, the second device for additive production 13b has produced a second object 4b essentially identically having a second production dataset 22b and a further unique identifier 23b. The production datasets 22a, b may be assigned to the objects 4a, b by means of the respective identifier 23a, b.

The data stream 1 also comprises an element 2, which comprises a batch dataset 28 and especially consists of the batch dataset 28 here. In the present case, this batch dataset 28 was inserted as an element 2 in addition to the geometry dataset 5 by the corresponding author 6a. This batch dataset 28 establishes the maximum number of the objects 4a, b to be produced according to the definition datasets 3a-c. The devices for additive production 13a, b check before the production of the respective object 4a, b on the basis of a comparison of the production datasets 23a, b present in the data stream 1 to the batch dataset 28 whether the production of a further object 4a, b is permissible. In this manner, for example, the geometry author 6 is given the option of monitoring and restricting the numeric production of the object 4a, b, for example, based on a corresponding compensation.

In the present case, the elements 2 of the data stream 1 are arranged sorted according to a sequence which results from a respective timestamp 20 of each element 2. The timestamp 20 corresponds to the point in time of the preparation of the respective element 2. Especially in the illustration of FIG. 2, the elements 2 become younger from left to right, so that—in accordance with the above description—the specification profile 27 forms the first element 2 of this sequence. Therefore, a newly prepared element 2 inserted into the data stream 1 is arranged at the right end of the series of the elements 2 in the illustration of FIG. 2.

The cryptological linking of the elements 2 will now be explained on the basis of FIG. 2. Firstly, the data stream 1 has a corresponding element hash value 18 for each element 2, which element hash valuc 18 was generated here by applying a key-dependent hash function to the respective element 2. The preparation of the digital signature of the element 2 can also comprise applying the private signature key for the digital signature to the respective element hash value 18 instead of to the element 2 to be digitally signed itself. A digital signature of the relevant element 2 itself is similarly thus also achieved.

In addition to the element hash values 18, the data stream 1 comprises a series of meta-hash values 19 and especially one meta-hash value 19 for each element 2 of the data stream 1, so that each meta-hash value 19 is assigned to one element 2. The meta-hash values 19 form a linked list, the sequence of which corresponds to the above-described sequence of the elements 2, to which the meta-hash values 19 are respectively assigned. In accordance with this sequence, a respective preceding meta-hash value 19 is assigned to each meta-hash value 19—with the exception of the first meta-hash value 19 of the linked list. Each meta-hash value 19 is generated by applying a key-dependent hash function to the assigned element 2, on the one hand, and to the preceding meta-hash value 19, on the other hand. An initial value 19a, which can be defined in an arbitrary manner per se, is assigned to the first meta-hash value 19, so that, notwithstanding the other meta-hash values 19, the first meta-hash value 19 is generated by applying the key-dependent hash function to the assigned element 2—i.e., the first element 2—on the one hand, and to the initial value 19a, on the other hand. In this manner, not only the integrity of the elements 2 individually, but rather also the integrity of the entirety of the elements 2 and the sequence thereof is cryptologically secured.

The insertion of a new element 2 into the data stream 1 is then performed, for example, in that the element 2 is sorted in at the end of the sequence of the elements 2, and an element hash value 18 is generated for this new element 2 by applying the hash function to the element 2. This element hash value 18 is also added to the data stream 1. Subsequently, the hash function is applied to this element hash value 18 and to the meta-hash value 19 of the previously last or youngest element 2, i.e., the element 2 previously sorted in at the end of the sequence, and in this manner the meta-hash value 19 is obtained and added to the data stream 1. In this manner, the cryptological linking of the element 2 can also be expanded to new element 2.

In any case, it can firstly be checked on the complete data stream 1 on the basis of the digital signature of each element 2 whether all elements 2 originate from the respective author 6a-c of the element 2 and/or the processor 10. Secondly, it can also be checked on the basis of the cryptological linking, for example according to the above description, that no element 2 inserted as described above was removed from the data stream 1 or modified in its sequence.

After every transmission of the data stream 1 upon the insertion of a new element 2 to the users 11, a check of the cryptological linking and of the digital signatures is carried out by the users 11. If an irregularity is established by a user 11, a warning message is sent to the remaining users 11.

Finally, the processors 10 also include a testing device 24, which subjects a produced object 4a, b after the physical transportation of the object 4a, b from the respective device for additive production 13a, b to the testing device 24—to a test process. This test process can be based on a test target, which can also be—not shown here, however—part of an element 2 of the data stream 1. Test values measured during the test process are inserted in accordance with the illustration of FIG. 2 in a test dataset 25 as an element 2 by the testing device 24 into the data stream 1.

1.-15. (canceled)

16. A method for cryptologically securing an additive production process, wherein a data stream comprises cryptologically linked elements for describing the production process, wherein the elements comprise at least one definition dataset for defining an object for additive production, wherein the at least one definition dataset at least partially spatially defines the object for the additive production and defines a starting material of the object for the additive production and wherein the at least one definition dataset is inserted by a respective author into the data stream and the cryptological linking is expanded to the at least one definition dataset, wherein the data stream is transferred via a system of computer networks to a device for additive production for producing the object by means of the additive production, wherein the integrity of the cryptological linking is checked, and wherein the device for additive production produces the object based on the at least one definition dataset by means of the additive production.

17. The method as claimed in claim 16, wherein the at least one definition dataset defines, at least for one spatial region of the object, a property of the object varying in dependence on a spatial position in the region.

18. The method as claimed in claim 16, wherein the at least one definition dataset for defining the starting material defines one or more thermoplastic materials.

19. The method as claimed in claim 16, wherein the at least one definition dataset defines a production process, in particular in respect of the type of the layer buildup, of the object, preferably the at least one definition dataset for defining the production process of the object defines a method for melt layering (fused filament fabrication, FFF or fused deposition modeling, FDM), selective laser sintering, selective laser melting, or high-speed sintering (HSS) as the production process of the object.

20. The method as claimed in claim 16, wherein the elements are each digitally signed.

21. The method as claimed in claim 16, wherein the elements of the data stream are sorted according to a sequence, and the sequence according to which the elements of the data stream are sorted corresponds to the chronological sequence according to the respective timestamp.

22. The method as claimed in claim 16, wherein a plurality of processors, comprising the respective authors of the at least one definition dataset, inserts a new element into the data stream, and the cryptological linking of the elements is expanded to the new element, in particular the inserting processor digitally signs the new element during the insertion.

23. The method as claimed in claim 22, wherein, after insertion of a new element, the data stream is transferred via the system of computer networks to a plurality of users, and stored in each case, is checked by the plurality of users, and if a lack of integrity is established, the establishing user transmits a warning message to the plurality of users.

24. The method as claimed in claim 22, wherein the plurality of processors comprises the device for additive production, and the device for additive production, after production of the object, inserts a production dataset having items of information on the process of the production of the object, as a new element into the data stream.

25. The method as claimed in claim 24, wherein the plurality of processors comprises a plurality of devices for additive production which are each arranged remotely from one another and connected to one another by the system of computer networks and which each produce a respective object by means of additive production based on the definition datasets, after production of the respective object, insert a respective production dataset having items of information on the process of the production of the respective object, as a respective new element into the data stream.

26. The method as claimed in claim 25, wherein, during the production of the object by the device for additive production, the unique identifier of the produced object is introduced into the produced object, so that the identifier can be read out from the produced object.

27. The method as claimed in claim 22, wherein the plurality of processors comprises a testing device for testing the produced object, the testing device carries out a test process on the produced object with measurement of test values, and the testing device, after carrying out the test process, inserts a test dataset having the measured test values as a new element into the data stream.

28. The method as claimed in claim 16, wherein the data stream comprises an element having a batch dataset, wherein the batch dataset defines a maximum number of objects to be produced based on the at least one definition dataset.

29. A data stream for cryptologically securing an additive production process, wherein the data stream comprises cryptologically linked elements for describing the production process, wherein the elements comprise at least one definition dataset for defining an object for additive production, wherein the at least one definition dataset at least partially spatially defines the object for the additive production and defines a starting material of the object for the additive production, and wherein the at least one definition dataset is configured for the purpose that a device for additive production produces the object by means of the additive production based on the at least one definition dataset.

30. A system for cryptologically securing an additive production process, having a respective author for inserting at least one definition dataset for defining an object for additive production into a data stream having cryptologically linked elements to describe the production process, wherein the at least one definition dataset at least partially spatially defines the object for the additive production and defines a starting material of the object for the additive production, having a device for the additive production for producing the object by means of the additive production based on the at least one definition dataset, having a system of computer networks for transferring the data stream to the device for additive production, wherein the device for additive production is configured to check the integrity of the cryptological linking.
